(19) United States
(12) Patent Application Publication
(10) Pub. No.: US 2004/0058175 A1
(43) Pub. Date: Mar. 25, 2004

(54) Layered composite sheet or layered composite film

(75) Inventors: Herbert Morgenstern, Ellerstadt (DE); Volker Hammes, Neustadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/671,456

(22) Filed: Sep. 29, 2003

Related U.S. Application Data
(63) Continuation of application No. 09/830,090, filed on May 15, 2001, now abandoned.
Application No. 09/830,090 is a 371 of international application No. PCT/EP99/07680, filed on Oct. 13, 1999.

(30) Foreign Application Priority Data
Oct. 22, 1998 (DE) 198 48 683.9

(51) Int. Cl. B32B 27/06

(52) U.S. Cl. 428/480

(57) ABSTRACT

A layered composite sheet or layered composite film made from thermoformable thermoplastics or mixtures of thermoplastics comprises at least one substrate layer and at least one outer layer. The outer layer comprises a lubricant.

The invention relates to a layered composite sheet or layered composite film made from thermoformable thermoplastics or mixtures of thermoplastics, comprising at least one substrate layer and at least one outer layer, and to a process for its production, moldings obtainable therefrom, and a process for producing moldings.

Lubricants are used in thermoplastic molding compositions to reduce viscosity (internal lubricants) and/or as lubricants acting between the plastic melt and surfaces of tooling (external lubricants).

Direct, uniform application of the lubricant to the molding element is difficult, and therefore the thermoplastic molding composition does not flow uniformly within the mold and varying wall thicknesses result in the molding. In addition, complicated removal of the lubricant is necessary.

EP-A 0 457 082 describes plastic films having one or more layers and having improved thermoformability, and having at least one layer of a mixture of plastics made from 55-95 parts by weight of a thermoplastic polyolefin elastomer and 45-5% by weight of another polyolefin or styrene block copolymer. The mixtures may comprise other fillers, stabilizers, dyes, lubricants and flame retardants.

If the lubricant is incorporated into the entire thermoplastic molding composition, relatively large amounts of lubricant have to be used to achieve sufficient lubricant action between plastic melt and mold. This can impair the mechanical, theological and thermal properties of the polymeric material.

Another way is to use “release liners”. Here, a plastic film is placed between the mold and polymeric material and pulled away again after the thermoforming process. For example, WO 90/13419 describes a release liner made from a film with a cured silicone layer as release agent.

In EP-A 0 113 117 a lubricant (dimethylsiloxane) is introduced between a thin skin of a thermoplastic (polyethylene) and the mold. The lubricant is removed with the skin after the thermoforming process.

Both the application and the removal of a plastic film imply additional operations in the production of a molding.

It is an object of the present invention to provide a thermoformable layered composite sheet or layered composite film which does not have the abovementioned disadvantages. In particular, when the layered composite sheet or layered composite film is thermoformed, even without additional release films, improved control of the wall thickness ratios should be possible and the sheet or film should have improved wall-slip performance and release of the molding should therefore be easier.

We have found that this object is achieved by means of a layered composite sheet or layered composite film made from thermoformable thermoplastics or mixtures of thermoplastics, comprising at least one substrate layer and at least one outer layer, where the outer layer comprises a lubricant.

The layers termed outer layers are those which during the thermoforming process come into contact with the molding element. The substrate layer may be composed of one or more layers of the same or different materials.

Suitable thermoformable thermoplastics are any of the plastics which can be formed thermoplastically without decomposing. Preference is given to glass-clear polystyrene (GPPS), impact-modified polystyrene (HIPS), styrene copolymers, such as styrene-butadiene block copolymers, ASA, SAN, ABS, polyolefins, such as polyethylene or polypropylene, acrylates or methacrylates, such as PMMA, polycarbonate (PC), polyvinyl chloride (PVC), polyethylene terephthalate (PET) or mixtures of these, in particular polyethylene/polystyrene blends.

The substrate layer and the outer layer of the layered composite sheet or layered composite film may be composed of the same, or of different, thermoformable thermoplastics. Use of different thermoplastics of mixtures of thermoplastics for the substrate layer and the outer layer is preferred.

The outer layer used is usually functional (a finishing layer), i.e. the outer layer has higher gloss, coloration, stress-cracking resistance, resistance to chemicals and environmental effects or a different surface structure.

The thickness of the outer layer of the layered composite sheet or layered composite film is generally from 10 to 1000 μM, preferably from 50 to 500 μm, and that of the substrate layer is in the range from 0.1 to 100 mm, preferably from 1 to 10 mm.

Suitable lubricants are those customary for plastics, such as metal soaps, paraffin waxes, waxy polymers, higher fatty alcohols and fatty esters or fatty amides or silicones. Preference is given to stearic acid or stearates, such as calcium stearate or zinc stearate.

The proportion of the lubricant is generally from 0.01 to 10% by weight, preferably from 0.1 to 1% by weight, based on the entire outer layer.

Both the outer layer and the substrate layer may comprise usual amounts of the auxiliaries customary in thermoplastic molding compositions. These include, for example: antiblocking agents, release agents, stabilizers, antistats, conductive additives, flame retardants, colorants, flexibilizers, plasticizers, coupling agents, fillers, reinforcing agents and blowing agents.

The layered composite sheets or layered composite films may be produced, for example, by coextrusion of a lubricant-containing thermoplastic or mixture of thermoplastics for the outer layer with thermoplastic or a mixture of thermoplastics for the substrate layer or lamination of the outer layer to a substrate layer.

The lubricant is preferably used in the form of a 0.1-50% strength by weight premix (masterbatch), particularly preferably a 1-10% strength by weight premix, in a thermoplastic. A masterbatch of this type may, for example, be prepared by extrusion of a thermoplastic with the lubricant. The amount of the masterbatch which is added to the thermoplastic or to the mixture of thermoplastics for the outer layer depends on the amount of lubricant desired to be present in the outer layer. Possible thermoplastics for the masterbatch are the abovementioned thermoplastics for the substrate layer or outer layer, and the thermoplastic for the masterbatch does not have to be that used for the outer layer. Preferred thermoplastics for the masterbatch are styrene-butadiene block copolymers. Particular preference is given to the elastomeric styrene-butadiene block copolymers with a random S/B block described in WO 95/35335.

The elastomeric block copolymers are composed of hard blocks S of vinylaromatic monomers and random soft blocks B/S of dienes and vinylaromatic monomers, and comprise at least the block structure S—B/S—S, where the diene content is less than 50% by weight and the proportion of the soft phase formed from the B/S blocks is at least 60% by weight, based in each case on the entire block copolymer.

An elastomeric block copolymer of this type is obtained by forming, within the scope of the parameters above, the soft phase from a random copolymer of a vinylaromatic with a diene, e.g. by polymerization in the presence of a polar cosolvent or of a potassium salt.

The random incorporation of the vinylaromatic compounds into the soft block B/S of the block copolymer, e.g. by the use of Lewis bases during the polymerization, affects the glass transition temperature (T_{g}). The glass transition temperature of the B/S soft block is preferably from −50 to +25° C., preferably from −50 to +5° C., particularly preferably from −50 to −15° C.

The glass transition temperature of the hard block S is preferably above 25° C., particularly preferably above 50° C.

The molar mass of an S block is preferably from 1000 to 200,000, in particular from 5000 to 50,000 [g/mol]. The molar mass of an S block is very particularly preferably from 10,000 to 20,000 g/mol. S blocks within a molecule may have different molar masses.

The molar mass of the B/S block is usually from 2000 to 250,000 [g/mol], preferably from 20,000 to 150,000 [g/mol].

The B/S block, like the S block, may assume different molar mass values within a molecule.

Preferred polymer structures are S—B/S—S, X—[—B/S—S]₂ and Y—[—B/S—S]₂, where X is the radical of a bifunctional coupling agent and Y is the radical of a bifunctional initiator. The random B/S block itself may have further subdivision into a number of blocks, e.g. (B/S)₁—(B/S)₂—(B/S)₃. The random block is preferably composed of from 2 to 15 random subblocks, particularly preferably of from 3 to 10 subblocks. The division of the random B/S block into a very large number of subblocks (B/S)ₙ gives the important advantage that, even if there is a gradient in the make-up within a subblock (B/S)ₙ, as is difficult to avoid (see below) in anionic polymerization under industrial conditions, the B/S block behaves overall as a virtually perfect random polymer. This gives the possibility of using less than the theoretical amount of Lewis base, and thus increasing the proportion of 1,4 diene linkages, reducing the glass transition temperature T_{g} and reducing the susceptibility of the polymer to crosslinking.

Preference is given to a block copolymer of one of the formulae [sic] S—B/S—S,

where

S is a vinylaromatic block, and

B/S is the soft phase made from a block built up randomly from diene units and vinylaromatic units.

The soft phase may have subdivision into blocks (B/S)₁—(B/S)₂, where the indices 1 and 2 represent different structures in the sense that the vinylaromatic/diene ratio is different in the individual B/S blocks or changes continuously within a block within the limits (B/S)₁(B/S)₂, where the glass transition temperature T_{g} of each subblock is below 25° C.

Particular preference is given to a soft block B/S which has been subdivided into a number of blocks (B/S)ₙ of identical make-up.

Preference is also given to a block copolymer which has a number of B/S and/or S blocks of different molar mass in each molecule.

Preferred vinylaromatic compounds are styrene, a-methylstyrene and vinyltoluene, and also mixtures of these compounds. Preferred dienes are butadiene and isoprene, piperylene, 1-phenylbutadiene and mixtures of these compounds.

A particularly preferred monomer combination is butadiene and styrene. All of the weight and volume data below are based on this combination. If the industrial equivalents of styrene and butadiene are used the data must be recalculated correspondingly, where appropriate.

The soft block B/S is preferably composed of from 75 to 30% by weight of styrene and from 25 to 70% by weight of butadiene. A soft block B/S particularly preferably has a butadiene proportion of from 35 to 70% and a styrene proportion of from 65 to 30%.

The proportion by weight of the diene in the entire block copolymer in the case of the monomer combination styrene/butadiene is from 15 to 50%, and that of the vinylaromatic component is correspondingly from 85 to 50%. Particular preference is given to butadiene-styrene block copolymers with a monomer make-up of from 25 to 40% by weight of diene and from 75 to 60% by weight of vinylaromatic compound.

The block copolymers can be obtained by anionic polymerization in 10 a nonpolar solvent with addition of a polar cosolvent or of a potassium salt, as described, for example, in WO 95/35335 or WO 97/40079.

The proportion by weight of the soft phase composed of diene and vinylaromatic sequences is from 60 to 95% by weight, preferably from 60 to 80% by weight and particularly preferably from 65 to 75% by weight. The S blocks of the vinylaromatic monomers form the hard phase, whose proportion by weight is correspondingly from 5 to 40%, preferably from 20 to 40% and particularly preferably from 25 to 35%.

The property profile of the block copolymers is very similar to that of plasticized PVC, but they can be prepared in such a way as to be entirely free from low-molecular-weight plasticizers which can migrate. They have high oxygen permeation P_{O} and water vapor permeation P_{W} of above 2000 [cm³·100 μm/m²·d·bar] and, respectively, above 10 [g 100 μm/m²·d·bar], where P_{O} is the amount of oxygen in cm³, and, respectively, P_{W} is the amount of hydrogen [sic] in grams, which permeate through 1 m² of film of standard thickness 100 μm per day and per bar of difference in partial pressure.

The layered composite sheet or layered composite film is suitable for producing moldings of any type, by thermoforming. The parameters for the thermoforming, such as temperatures of the mold or supplementary heating systems, are adjusted as appropriate for the thermoplastic used in the layered composite sheet or film. The mold temperature usually used is from about 50 to 120° C. The moldings are suitable for any application in which thermoformed plastic parts are used. They are particularly suitable for internal casings in refrigeration equipment, for motor vehicle components, such as motor vehicle soft trims or roof boxes, and for leisure items and sanitary items, and also advertising media, such as displays.

In the refrigeration equipment industry use is frequently made of two-layer composite sheets in which the substrate layer is composed of impact-modified and stress-cracking-resistant polystyrene and the outer layer is a gloss layer comprising a mixture of standard polystyrene and impact-modified polystyrene.

The process is highly cost-effective. It is not necessary to spray lubricant onto the element used in the operation or to insert and pull away release films. Since the lubricant is only present in the thin outer layer, the mechanical, thermal and Theological properties of the material are unimpaired, or only very slight impaired. The better wall-slip performance enlarges the processing range, i.e. the thermoforming process can, for example, take place at lower temperatures. This can reduce degradation of the material, for example reducing yellowing. Smaller forces for forming reduce the scrap rate, and smaller forces for demolding inhibit damage to the material or molding, for example by “crazes” or stress-whitening. Other advantages are avoidance of wrinkles and a reduction in thermal-shock markings.

The improved wall-slip performance reduces the high wall thicknesses at the first areas of contact with the thermoforming mold, and it is therefore possible to save on the use of excess material. This material which is saved reinforces the remainder of the structure of the thermoformed molding and in the end allows a reduction in sheet thickness with the associated cost savings.

Thermoforming of the novel layered composite sheets or layered composite films can also give access to relatively demanding designs, e.g. molded sections with small radii of curvature, deep incisions, or high degrees of stretching or undercuts. Since the lubricant remains in the outer layer the molding is less susceptible to scratching.

Reaction of a lubricant takes place at the interface of the outer layer with the thermoforming mold, which may be composed of metal, wood or glass-fiber-reinforced plastic (GRP). The use of a styrene-butadiene block copolymer in the outer layer additionally encourages diffusion of the lubricant to the surface and thus improves the longitudinal/transverse orientation balance.

### EXAMPLES

Masterbatch MB: The masterbatch used in the examples comprised 95% by weight of a styrene-butadiene block copolymer as in Example 1 of WO 95/35335 and 5% by weight of calcium stearate.

PS1: Impact-modified polystyrene with a melt volume rate MVR 200/5 of 4, a tensile modulus of elasticity of 1500 MPa and a yield stress of 21 MPa (polystyrene 2710 from BASF AG)

PS2: Impact-modified polystyrene with a melt volume rate MVR 200/5 of 4, a tensile modulus of elasticity of 1900 MPa and a yield stress of 32 MPa (polystyrene 585 K from BASF AG)

PS3: Impact-modified polystyrene with a melt volume rate MVR 200/5 of 10, a tensile modulus of elasticity of 3300 MPa and a breaking stress of 46 MPa (polystyrene 143 E from BASF AG)

PS4: Impact-modified polystyrene with a melt volume rate MVR 200/5 of 7.5, a tensile modulus of elasticity of 1400 MPa and a yield stress of 17 MPa (polystyrene 2712 from BASF AG)

### Example 1

Coextruded sheets were produced with a substrate layer of PS1 and an outer layer (gloss layer) of 0.1 mm thickness made from 48.5% by weight of PS2, 48.5% by weight of PS3 and 3% by weight of MB. The thickness of the substrate layer was varied from 3.0 to 4.1 mm.

### Comparative Experiment C1

Coextruded sheets were produced with a substrate layer of PS1 and an outer layer (gloss layer) of 0.1 mm thickness made from 50% by weight of PS2 and 50% by weight of PS3. The thickness of the substrate layer was varied from 3.0 to 4.1 mm.

The coextruded sheets from Example 1 and those from the comparative example were thermoformed under identical conditions with the outer layer toward the mold, by positive thermoforming on an Illig UA 100 ED, to give receptacles. The quality of the thermoformed receptacles was assessed visually and the results are given in Table 1.

TABLE 1
Demolding performance of receptacles made from
coextruded sheets

| Thickness of | | | |
|---|---|---|---|
| substrate | | | |
| layer | Overall thick- | | |
| [mm] | ness [mm] | E1 | C1 |
| 4.1 | 4.2 | Good | Good |
| 4.0 | 4.1 | Good | Good |
| 3.9 | 4.0 | Good | Good |
| 3.8 | 3.9 | Good | Good |
| 3.7 | 3.8 | Good | Cracking on demolding |
| 3.6 | 3.7 | Good | Cracking on demolding |
| 3.5 | 3.6 | Good | Cracking on demolding |
| 3.4 | 3.5 | Good | Cracking on demolding |
| 3.3 | 3.4 | Good | Cracking on demolding |
| 3.2 | 3.3 | Good | Cracking on demolding |
| 3.1 | 3.2 | Cracking on | Cracking on demolding |
| | | demolding | |
| 3.0 | 3.1 | Cracking on | Cracking on demolding |
| | | demolding | |

The results shown in Table 1 indicate that when the lubricant-containing masterbatch is used in the outer layer it is possible to achieve good demolding of the container at an overall sheet thickness down to 3.3 mm. In the comparative experiment without lubricant, break-up during shaping and, respectively, damage through stress-whitening or cracking during demolding were already beginning to occur at an overall sheet thickness of 3.8 mm. The sheet thickness reduction possible in Example 1 corresponds to a material saving of about 15% over Comparative Example C1.

### Example 2

A coextruded sheet was produced with a substrate layer of 3.8 mm thickness made from PS1 (color white 744) and with an outer layer of 0.2 mm thickness made from 98% by weight of PS1 and 0.2% by weight of stearic acid. The stearic acid was applied to the PS1 in a drum mixer prior to coextrusion.

### Comparative Example C2

The extruded single-layer sheet used was of 4 mm thickness and made from PS1 (color White 744).

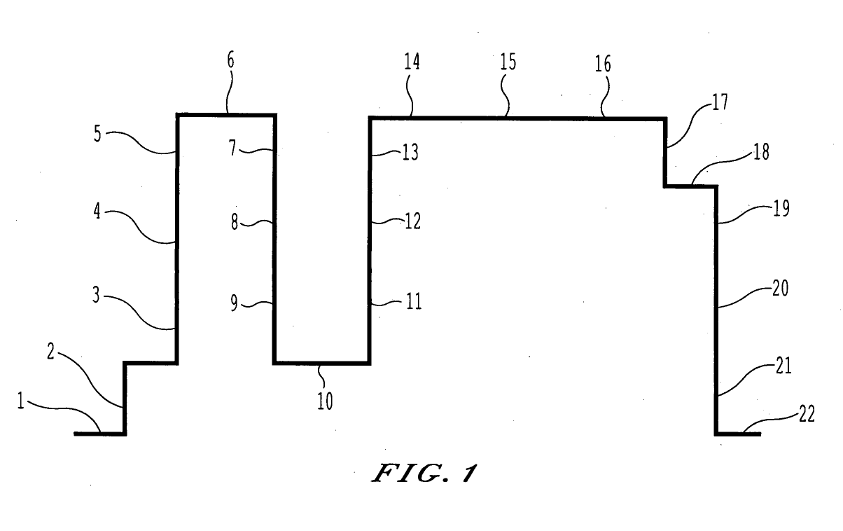

The coextruded sheets (sheet dimensions: 660×410 mm, overall thickness 4 mm) from Example 2 and the single-layer sheet from Comparative Example C2 were thermoformed under identical conditions with the outer layer toward the mold, by positive thermoforming on an Illig UA 100 ED, to give internal receptacles for refrigerators. The mold temperature was 80° C. The internal receptacles for refrigerators were cut open, and their wall-thickness profile was assessed. FIG. 1 shows a cross section of the container and the locations at which the wall thickness was measured. The results for Example 2 and Comparative Example C2 are given in Table 2. The lowest wall thickness along the section was significantly greater for the container from Example 2 than for that from Comparative Example 2.

TABLE 2
Thickness distribution in a thermoformed internal
container for a mini-refrigerator

Material thickness after
thermoforming*) [mm]

| Measurement | Single-layer | Coextruded |
|---|---|---|
| point | sheet C2 | sheet E2 |
| 1 | 0.7 | 0.7 |
| 2 | 0.4 | 0.45 |
| 3 | 0.65 | 0.7 |
| 4 | 0.75 | 0.8 |
| 5 | 0.9 | 0.85 |
| 6 | 0.85 | 0.8 |
| 7 | 1.4 | 1.25 |
| 8 | 0.6 | 0.8 |
| 9 | 0.5 | 0.7 |
| 10 | 1.9 | 1.8 |
| 11 | 0.5 | 0.8 |
| 12 | 0.5 | 0.9 |
| 13 | 1.7 | 1.4 |
| 14 | 2 | 1.55 |
| 15 | 1.9 | 1.5 |
| 16 | 1.7 | 1.35 |
| 17 | 1.2 | 0.95 |
| 18 | 1.05 | 0.9 |
| 19 | 1.7 | 1.4 |
| 20 | 0.55 | 0.9 |
| 21 | 0.65 | 0.75 |
| 22 | 0.95 | 1.1 |
| Average thickness | 1.05 | 1.02 |
| Coefficient of variation | 0.53 | 0.34 |

*)Measured along the center line in a longitudinal section using Panametrics ultrasound thickness-measurement equipment

### Example 3

A coextruded sheet was produced with a substrate layer of 4.6 mm thickness made from PS4 and with an outer layer of 0.2 mm thickness made from 95% by weight of PS4 and 5% by weight of MB.

### Comparative Example C3

The extruded single-layer sheet used was of 4.8 mm thickness and made from PS4.

The coextruded sheets from Example 3 and the single-layer sheet from Comparative Example C3 were thermoformed under identical conditions with the outer layer toward the mold, by positive thermoforming on an Illig UA 100 ED, to give internal receptacles for refrigerators.

After a short storage time there were yellow streaks in the rim area on the inner side of the receptacle made from the single-layer sheet of Comparative Example 3. The streaks indicate the lines of contact of the upper corners of the mold when the thermoforming mold is inserted into the bubble previously formed by use of compressed air. Even after five weeks' storage time, no streaks could be seen on the internal receptacles for refrigerators made from the coextruded sheet of Example 3.

We claim:

1. A layered composite sheet or layered composite film made from thermoformable thermoplastics or mixtures of thermoplastics, comprising at least one substrate layer and at least one outer layer, wherein the outer layer comprises a lubricant.

2. A layered composite sheet or a layered composite film as claimed in claim 1, wherein the substrate layer and the outer layer are composed of the same, or of different, thermoformable thermoplastics, selected from the class consisting of glass-clear or impact-modified polystyrene, styrene copolymers, polyolefins, polyvinyl chloride, polyethylene terephthalate and mixtures of these.

3. A layered composite sheet or a layered composite film as claimed in claim 1 or 2, wherein the thickness of the outer layer is from 10 to 1000 μm.

4. A layered composite sheet or a layered composite film as claimed in any one of claims 1 to 3, wherein the proportion of the lubricant is from 0.01 to 10% by weight, based on the outer layer.

5. A layered composite sheet or a layered composite film as claimed in any one of claims 1 to 4, wherein stearic acid or stearates are used as lubricant.

6. A layered composite sheet of layered composite film as claimed in any one of claims 1 to 5, wherein the outer layer has higher gloss than the substrate layer.

7. A process for producing a layered composite sheet or layered composite film as claimed in any one of claims 1 to 6 by coextrusion of a lubricant-containing thermoplastic or mixture of thermoplastics for the outer layer with a thermoplastic or mixture of thermoplastics for the substrate layer or lamination of at least one outer layer to a substrate layer.

8. A process as claimed in claim 7, wherein the lubricant is in the form of a 0.1-50% strength by weight premix in a styrene-butadiene block copolymer when added to the thermoplastic or to the mixture of thermoplastics for the outer layer.

9. A process for producing moldings by thermoforming a layered composite sheet or layered composite film as claimed in any one of claims 1 to 6.

10. A molding produced from a layered composite sheet or layered composite film as claimed in any one of claims 1 to 6.
